(19) United States
(12) Patent Application Publication
(10) Pub. No.: US 2016/0313281 A1
(43) Pub. Date: Oct. 27, 2016

(54) BIOMOLECULAR ANALYSIS DEVICE

(71) Applicant: SHARP KABUSHIKI KAISHA, Osaka-shi (JP)

(72) Inventors: Shinichi GOTO, Osaka-shi (JP); Hideki KINOSHITA, Osaka-shi (JP); Yutaka UNUMA, Osaka-shi (JP)

(21) Appl. No.: 15/104,264

(22) PCT Filed: Dec. 2, 2014
(86) PCT No.: PCT/JP2014/081856

§ 371 Date: Jun. 14, 2016

(30) Foreign Application Priority Data
Dec. 19, 2013 (JP) 2013-262973

(51) Int. Cl. G01N 27/447

(52) U.S. Cl. CPC G01N 27/44739; G01N 27/44778

(57) ABSTRACT

The present invention provides a biomolecular analysis device which suitably realizes sample adsorption. According to an embodiment of the present invention, a biomolecular analysis device (1) includes: a sample separating section (5); a pressing tool (6); and a transfer film (7) which is provided between the sample separating section (5) and the pressing tool (6). The pressing tool (6) (i) presses, with a fixed pressure, the transfer film (7) toward a second opening (58) of the sample separating section (5) and (ii) restricts a region which is located between the sample separating section (5) and the second buffer solution tank (4) and in which there is a buffer solution.

### TECHNICAL FIELD

The present invention relates to a biomolecular analysis device in which (i) a biomolecule sample in a separation medium is separated into separated biomolecule samples and then (ii) separated biomolecule samples are adsorbed to a sample adsorbing member.

### BACKGROUND ART

In the field of proteome analysis which plays a major role in post-genome research, a combination of a two dimensional electrophoresis (2DE) method and the western blotting method is known an excellent separation analysis method. With 2DE, it is possible to separate a proteome into a plurality of components (proteins) (i) based on two physical properties (electric charge and molecular weight) which are unique to proteins, (ii) by use of various separation media, and (iii) with a high resolution. In a case where the proteins are further analyzed with the use of results of separation by 2DE, it is preferable that the plurality of proteins contained in the separation medium are fixed to a transfer film by the western blotting method. This is because the proteins fixed to the transfer film can be stably kept for an extended period of time and can be easily analyzed. The western blotting method can be deemed essential particularly in a case where a plurality of biological characteristics of a protein, such as increase/decrease in expression level of the protein and presence/absence of post-translational modification, are to be exhaustively compared and studied with the use of results of separation by 2DE.

In a case of a well-known method in which 2DE and the western blotting method are independently carried out by use of respective devices, it is necessary to (i) carry out electrophoresis, (ii) take a separation medium out of an electrophoresis device, (iii) move the separation medium to a transfer device, (iv) set a transfer film in the transfer device so as to carry out transfer. However, if a manual operation of a researcher is involved between the electrophoresis and the transfer, then reproducibility of obtained results unfortunately becomes low. In addition, since an extremely soft and breakable gel is used as a separation medium, the western blotting method requires experience.

Meanwhile, Patent Literature 1 proposes a technology for carrying out capillary electrophoresis (CE) in which a capillary used, the technology being configured so that electrophoresis and transfer are both carried out by use of a single device. Specifically, a sample, which passes through a capillary (including a gel or solution therein) and is released from the capillary, is adsorbed, as it is, to a transfer film. This allows a single device to carry out steps from a step of separation to a step of collection (fixing of a sample to a transfer film). With the technology, it is possible to consecutively carry out electrophoresis and transfer.

### CITATION LIST

### [Patent Literature]

[Patent Literature 1]

Japanese Patent Application Publication Tokukaihei No. 4-264253 (Publication date: Sep. 21, 1992)

### SUMMARY OF INVENTION

### Technical Problem

However, the technology disclosed in Patent Literature 1 poses the following problem: In a case where a sample having been subjected to separation by electrophoresis is adsorbed to the transfer film, a minimum value of resolution is theoretically as low as a diameter of an end part of a capillary. No greater resolution can be obtained. In addition, during actual transfer, a sample released from the capillary may be scattered before being adsorbed to the transfer film, and consequently an adsorption pattern of the sample on the transfer film may become unclear. Furthermore, since the technology disclosed in Patent Literature 1 concerns direct transfer of a sample which has been separated by capillary electrophoresis. This makes it basically impossible to carry out two dimensional separation and development.

The present invention has been made in view of the problem, and it is an object of the present invention to provide a biomolecular analysis device which (i) makes it possible to consecutively carry out steps from a step of separating a sample by electrophoresis to a step of transferring the sample to a sample adsorbing member and (ii) achieves high-resolution sample adsorption.

### Solution to Problem

In order to attain the object, a biomolecular analysis device of the present invention is a biomolecular analysis device in which (i) an electric current is allowed to flow through a separation medium via a buffer solution so that a sample in the separation medium is separated into separated biomolecule samples and then (ii) the separated biomolecule samples are released from the separation medium and then adsorbed to an adsorbing member, said biomolecular analysis device including: a first electrode; a second electrode; a separating section for storing the separation medium, the separating section having (i) a first opening which is made on a side facing toward the first electrode and (ii) a second opening which is made on a side facing toward the second electrode; and a pressing tool which is located between the separating section and the second electrode, the pressing tool sandwiching an elastic member, which has an insulating property, between a first structure and a second structure, the first structure being provided on a side facing toward the separating section, and the second structure being provided and positionally fixed on a side facing toward the second electrode, the first structure having a first through-hole which is located at a position facing the second opening and which penetrates through the first structure from the side facing toward the separating section to a side facing toward the second electrode, the second structure having a second through-hole which is located at a position facing the second opening and which penetrates through the second structure from a side facing toward the separating section to the side facing toward the second electrode, the adsorbing member being provided between the second opening and the first through-hole, the elastic member pressing the first structure toward the separating section, the elastic member having a loop shape which surrounds an opening of the first through-hole on the side facing toward the second electrode and which surrounds an opening of the second through-hole on the side facing toward the separating section such that the elastic member having the loop shape restricts a channel of a buffer solution between the opening of the first through-hole and the opening of the second through-hole.

### Advantageous Effects of Invention

With the present invention, it is possible to provide a biomolecular analysis device which (i) makes it possible to consecutively carry out steps from a step of separating a sample by electrophoresis to a step of transferring the sample to a sample adsorbing member and (ii) achieves high-resolution sample adsorption.

### BRIEF DESCRIPTION OF DRAWINGS

FIG. 1 is a top view illustrating a configuration of an embodiment of a biomolecular analysis device according to the present invention.

FIG. 2 is a cross-sectional view of the biomolecular analysis device illustrated in FIG. 1.

FIG. 3 is a view schematically illustrating a spread of lines of electric force in a region of the biomolecular analysis device illustrated in FIG. 1.

FIG. 4 is an exploded perspective view illustrating, in portions, part of the configuration of the biomolecular analysis device illustrated in FIG. 1.

FIG. 5 is an exploded perspective view illustrating, in portions, part of the configuration of the biomolecular analysis device illustrated in FIG. 1.

FIG. 6 is a perspective view illustrating part of the configuration of the biomolecular analysis device illustrated in FIG. 1.

FIG. 7 is a perspective view illustrating part of the configuration of the biomolecular analysis device illustrated in FIG. 1.

FIG. 8 is a cross-sectional view illustrating how a sample separating section to be configured in the biomolecular analysis device illustrated in FIG. 1 is attached to a predetermined position of a housing which is to be configured in the device.

FIG. 9 is a cross-sectional view illustrating a variation of a pressing tool configured in the biomolecular analysis device illustrated in FIG. 1.

FIG. 10 is an exploded perspective view illustrating a variation of the pressing tool configured in the biomolecular analysis device illustrated in FIG. 1.

FIG. 11 is an exploded perspective view illustrating a variation of the pressing tool to be configured in the biomolecular analysis device illustrated in FIG. 1, which pressing tool is to be attached to the housing configured in the device.

FIG. 12 is a view illustrating how a biomolecule sample is adsorbed to a sample adsorbing member in the biomolecular analysis device illustrated in FIG. 1.

### DESCRIPTION OF EMBODIMENTS

### Embodiment 1

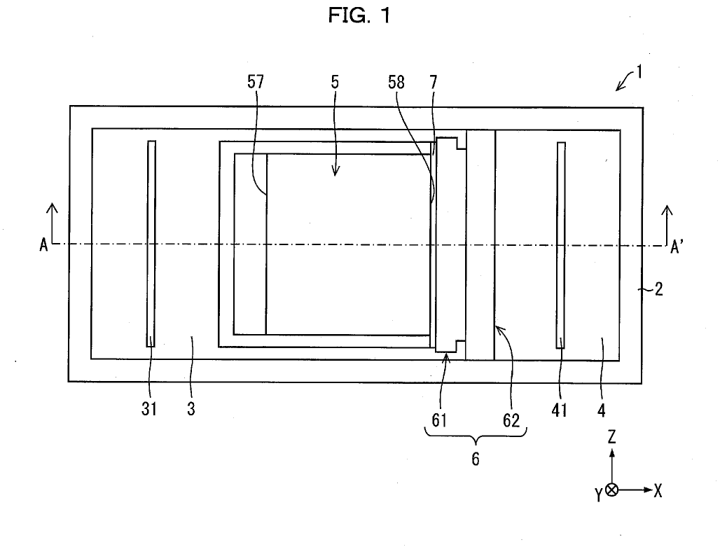

The following description will discuss, with reference to FIGS. 1 through 8, the details of an embodiment of a biomolecular analysis device in accordance with the present invention.

(1) Configuration of Biomolecular Analysis Device

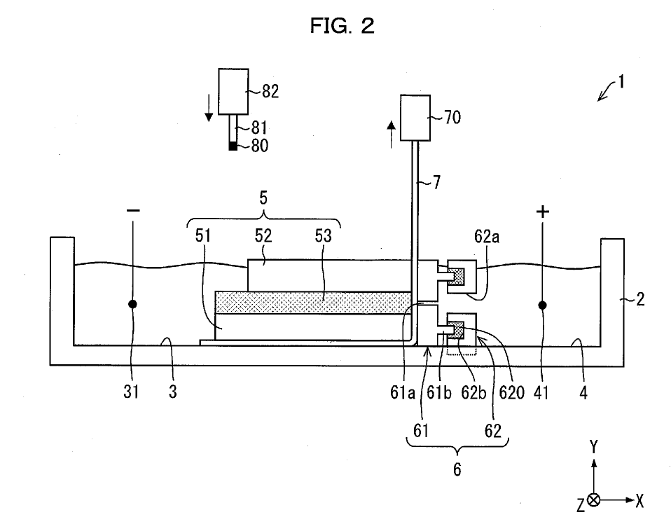

A configuration of a biomolecular analysis device according to Embodiment 1 will be schematically described below with reference to FIGS. 1 and 2. FIG. 1 is a top view schematically illustrating a biomolecular analysis device 1. FIG. 2 is a cross-sectional view taken along the line A-A′ illustrated in FIG. 1.

The biomolecular analysis device 1 of Embodiment 1 is configured to (i) separate a biomolecule sample component into separated biomolecule samples according to a molecular weight and then (ii) cause the separated biomolecule samples to be transferred (adsorbed) to a transfer film. The biomolecular analysis device 1 therefore includes: a housing 2; a first buffer solution tank 3 in which a cathode 31 (first electrode) is to be provided; a second buffer solution tank 4 in which an anode 41 (second electrode) is to be provided; a sample separating section 5 (separating section, second dimensional electrophoresis section); a pressing tool 6; a transfer film 7 (adsorbing member); a transfer film moving arm 70 (adsorbing member moving section) (see FIG. 2); and a sample introducing arm 82 (medium moving section) (see FIG. 2). The first buffer solution tank 3, the second buffer solution tank 4, the sample separating section 5, the pressing tool 6, and the transfer film 7 are provided in the housing 2.

The sample separating section 5 has (i) a first opening 57 which faces toward the first buffer solution tank 3 and (ii) a second opening 58 which faces toward the second buffer solution tank 4. In other words, the first opening 57 faces toward the cathode 31, whereas the second opening 58 faces toward the anode 41. This causes the biomolecular analysis device 1 to be configured so that in a case where the first buffer solution tank 3 and the second buffer solution tank 4 are filled with respective buffer solutions, the cathode 31 in the first buffer solution tank 3 and the anode 41 in the second buffer solution tank 4 are electrically connected to each other via (i) the buffer solutions in the respective two tanks (first buffer solution tank 3, second buffer solution tank 4), (ii) a separation gel 53 (separation medium) (see FIG. 2) which is stored in the sample separating section 5, and (iii) the transfer film 7. That is, the biomolecular analysis device 1 is configured so that in a case where voltage is applied across the cathode 31 and the anode 41, it is possible to (i) separate, with the use of the separation gel 53 in the sample separating section 5 (see FIG. 2), a biomolecule sample which has been introduced from the first opening 57, (ii) discharge separated components from the second opening 58, and (iii) cause the separated components to be adsorbed to the transfer film 7.

Note that the following description will assume that (i) an axis, along which a biomolecule sample is separated in the biomolecular analysis device 1, is an x-axis (first axis) which extends through the cathode 31 and the anode 41, (ii) an axis, along which the transfer film 7 moves in a moving direction, is a y-axis (second axis), and (iii) an axis perpendicular to the x-axis and to the y-axis is a z-axis.

(Cathode 31 and Anode 41)

The cathode 31 is provided in the first buffer solution tank 3, and the anode 41 is provided the second buffer solution tank 4.

The cathode 31 and the anode 41 area each made of an electroconductive material such as metal. In order to restrict ionization of the electrodes, for example, the electroconductive material for the cathode 31 and the anode 41 is preferably platinum.

In terms of arrangement of the electrodes, it is preferable that the cathode 31, the second opening 58, and the anode 41 are arranged substantially in line. It is further preferable that a slit 61a (first through-hole) and a through-hole 62a (second through-hole) of the pressing tool 6 (the slit 61a and the through-hole 62a are described later) are also arranged in line with the cathode 31, the second opening 58, and the anode 41. In a case where the transfer film 7 is provided as illustrated in FIGS. 1 and 2 while the above members are thus arranged, lines of electric force passing through the second opening 58 become substantially perpendicular to the transfer film 7. This can result in an increase in precision with which a biomolecule sample is adsorbed to the transfer film 7.

The anode 41 is provided apart from the transfer film 7. This can prevent bubbles, which are generated from the anode 41, from having an adverse effect on adsorption of separated components to the transfer film 7.

Note that the cathode 31 and the anode 41 can be provided in advance in the first buffer solution tank 3 and the second buffer solution tank 4, respectively. Alternatively, in a case where the housing 2 is to be covered with a lid, it is possible to suspend the cathode 31 and the anode 41 from a bottom surface of the lid so that, when the housing 2 is covered with the lid, the cathode 31 and the anode 41 are provided in the first buffer solution tank 3 and the second buffer solution tank 4, respectively.

(First Buffer Solution Tank 3 and Second Buffer Solution Tank 4)

The first buffer solution tank 3 and the second buffer solution tank 4 are formed by dividing the inside of the housing 2 into two tanks through providing the sample separating section 5 in the housing 2.

Buffer solutions to be provided in respective of the first buffer solution tank 3 and the second buffer solution tank 4 can each be any electroconductive buffer solution which can be used as a well-known buffer solution for electrophoresis, provided that there is no risk of an adverse effect on the separation gel 53 and the transfer film 7.

A cathode-specific buffer solution (first buffer solution) to be provided in the first buffer solution tank 3 is preferably a buffer solution which contains 3-(morpholino)propanesulfonic acid (MOPS) or tris(hydroxymethyl)aminomethane (Tris). An anode-specific buffer solution (second buffer solution) to be provided in the second buffer solution tank 4 is preferably a buffer solution which contains ethanol and which has a pH of 6.5 to 8.8. In a case where these buffer solutions are used, the separation gel 53, which is stored in the sample separating section 5 illustrated in FIG. 2, is preferably a gel produced by use of a buffer solution which contains Bis-Tris or tris(hydroxymethyl)aminomethane (Tris).

More preferably, the cathode-specific buffer solution, the anode-specific buffer solution, and the separation gel have the following compositions:
Anode-specific buffer solution
   100 mM MOPS (pH of 7.3)
   50 mM tris (hydroxymethyl)aminomethane (Tris)
   50 mM Bis-Tris
   20% ethanol
Cathode-specific buffer solution
   100 mM MOPS (pH of 7.2)
   50 mM Tris
   50 mM Bis-Tris
   0.25% sodium dodecyl sulfate (SDS)
Separation gel
   10% polyacrylamide gel which is produced by use of Tris-HCl buffer having a pH of 6.8

(Sample Separating Section 5)

As has been described, the sample separating section 5 has (i) the first opening 57 which faces toward the first buffer solution tank 3 and which serves as a sample supplying medium connecting section and (ii) the second opening 58 which faces toward the second buffer solution tank 4 and which serves as a sample component outlet.

As illustrated in FIG. 2, the sample separating section 5 is configured as follows: Two plates (lower plate 51 and upper plate 52) each having an x-z plane are overlapped along the y-axis with a predetermined space therebetween. The separation gel 53 (separation medium) is stored in the space. Each of the two plates is made of an insulator such as a glass insulator or an acrylic insulator. The separation gel 53 faces the inside of the first buffer solution tank 3 via the first opening 57, and faces the inside of the second buffer solution tank 4 via the second opening 58.

Of the two plates included in the sample separating section 5, the lower plate 51 provided on a bottom side has an end part which faces toward the first opening 57. The end part of the lower plate 51 protrudes further than an end part of the upper plate 52. This causes an upper part of the separation gel 53, which part corresponds to the first opening 57, to be exposed (see FIG. 2). Therefore, it is possible to introduce a biomolecule sample from the exposed part.

The separation gel 53 is intended to separate, according to a molecular weight, a biomolecule sample component which has been introduced from the first opening 57. Examples of the separation gel 53 encompass acrylamide gel and agarose gel. The separation gel 53 is preferably compatible with a buffer solution having the suitable composition described above. The separation gel 53 can be formed so as to fill the inside of the sample separating section 5 either before or after the sample separating section 5 is provided in the housing 2.

Note that according to Embodiment 1, the inside of the sample separating section 5 is filled with the separation gel 53. Alternatively, multiple ultrafine pillars called nanopillars can be provided between the two plates which face each other and are included in the sample separating section 5.

Alternatively, the second opening 58 of the sample separating section 5 and a part surrounding the second opening 58 can be covered with a covering part (electroconductive medium: not illustrated) which is made of a porous material. This allows for a decrease in frictional resistance and damage which the transfer film 7 receives from the sample separating section 5 and the separation gel 53 when the transfer film 7, which is in contact with or pressed against the second opening 58, is being conveyed.

The porous material for the covering part preferably has fine pores that pass through the porous material, and is preferably hydrophilic, slightly sample-adsorbable, and highly strong. This allows separated components to suitably pass through a segment of the covering part, which segment is located at a pathway through which the separated components pass.

For example, a porous material, which has fine pores passing through the porous material and which is hydrophilic, allows the second opening 58 to be sufficiently filled with the separation gel 53 and allows the fine pores to be filled with the separation gel 53 when the sample separating section 5 is filled with the separation gel 53. This allows the transfer film 7 and the separation gel 53 to come into close contact with each other. Therefore, it is possible to certainly prevent separated components from being scattered into a buffer solution. This allows stable electrical conduction to be maintained.

Examples of the material for the covering part encompass film materials such as a hydrophilic PVDF (Polyvinylidene difluoride) film and a hydrophilic PTFE (Polytetra fluoro ethylene) film. Examples of a method of attaching the covering part to the sample separating section 5 encompass (i) a method in which a sticky tape or an adhesive is used and (ii) a method in which the sample separating section 5 and the covering part are sandwiched and fixed together by use of a clip or the like.

Examples of a method of providing the separation gel 53 in the covering part encompass a method in which (i) the covering part is attached to the second opening 58 and to a part around the second opening 58 and then (ii) the sample separating section 5 is filled with the separation gel 53. For example, in a case where the separation gel 53 is a polyacrylamide gel, it is only necessary to (i) pour an acrylamide solution, which has not been subjected to gel polymerization, from a side of the sample separating section 5 to which the covering part has been attached, which side faces toward the first opening 57 and then (ii) subjects the acrylamide solution to gel polymerization.

According to a conventional method, covering a sample component outlet with a covering part causes lines of electric force to be unnecessarily widened while passing through the covering part. This poses a problem that a biomolecule sample is further scattered before reaching a transfer film. In a case where the biomolecular analysis device 1 of Embodiment 1 is used, in contrast, lines of electric force are converged by the slit 61a as described later even though the second opening 58 is covered with the covering part. The biomolecular analysis device 1 of Embodiment 1 thus prevents the problem.

(Transfer Film 7)

The transfer film 7 is preferably a member for adsorbing and holding a biomolecule sample which has been subjected to separation by the separation gel 53, the member (i) allowing a biomolecule sample to be stably stored and then (ii) facilitating an analysis of the biomolecule sample. The transfer film 7 is preferably made of a material which is highly strong and which has a high sample binding capacity (adsorbable weight per unit area). In a case where a sample is a protein, a PVDF film or the like is suitable as the transfer film 7. The PVDF film is preferably subjected to a hydrophilization treatment in advance by use of methanol or the like. Alternatively, the transfer film 7 can be a film which has conventionally been used for adsorption of protein, DNA, and nucleic acid. Examples of such a conventional film encompass a nitrocellulose film and a nylon film.

Note that examples of a biomolecule sample, which can be separated and adsorbed in the biomolecular analysis device 1, encompass, but are not limited to, protein, DNA, and RNA. Other examples of the biomolecule sample encompass (i) a preparation of a biological material (e.g. organism, body fluid, cell line, tissue culture, or tissue fragment) and (ii) a commercially available reagent such as polypeptide or polynucleotide.

The transfer film 7 extends, along a y-z plane, between the second opening 58 and the slit 61a of a slit structure 61 (first structure). In Embodiment 1, the transfer film 7 is configured in advance to be long so as to be able to be pulled up along the y-axis. Therefore, (i) one end part of the transfer film 7, which is long, is inserted below a bottom part of the sample separating section 5 so as to be located at a bottom part of the inside of the first buffer solution tank 3 and (ii) the other end part of the transfer film 7 is held by the transfer film moving arm 70. While a biomolecule sample is subjected to separation and adsorption the transfer film moving arm 70 drives so as to convey the transfer film 7 in a direction indicated by an arrow appearing next to the transfer film moving arm 70 in FIG. 2 (toward a positive side of the y-axis).

In Embodiment 1, as illustrated in FIG. 2, the transfer film 7 (i) has the one end part which is located at the bottom part of the inside of the first buffer solution tank 3 and (ii) has a predetermined length between the one end part and the other end part. However, the present invention is not limited to such a configuration. Alternatively, it is possible that a transfer film roll, around which the transfer film is wound, is formed at the one end part so that the transfer film 7 is configured to be drawn out from the transfer film roll. This allows a transfer film of a desired length to pass between the second opening 58 and the slit 61a of the slit structure 61. Note that the transfer film roll is rotatably attached to an inner wall of a main body of the biomolecular analysis device 1. In order to prevent the transfer film 7 from being dry while a biomolecule sample is subjected to separation and adsorption, the transfer film roll is preferably provided at a height so that the transfer film roll is located in a buffer solution while the biomolecule sample is subjected to separation and adsorption. In addition, in order to restrict adherence of bubbles from each of the electrodes to the transfer film 7, the transfer film roll is preferably provided away from each of the electrodes.

Note that a guide having a rotating axis, for example, can be provided as necessary so as to guide the transfer film 7 into a predetermined pathway while the transfer film 7 is conveyed.

Note also that the biomolecular analysis device 1 can be provided so that the transfer film 7 is already attached or is to be attached later, depending on a user. In either case, the transfer film 7 is used while being immersed in a buffer solution.

(Transfer Film Moving Arm 70)

As illustrated in FIG. 2, the transfer film moving arm 70 is configured to pull up the transfer film 7 in a direction toward the positive side of the y-axis. However, the present invention is not limited to such a pull-up system. Alternatively, the transfer film moving arm 70 can be configured as a transfer film collecting member which winds the transfer film 7 by a rotational motion. In a case where the transfer film collecting member is used, unlike the transfer film moving arm 70 which pulls up the transfer film 7 in the direction toward the positive side of the y-axis, it is unnecessary to secure a wide driving range. This allows the biomolecular analysis device 1 to be small in size.

(Sample Introducing Arm 82)

As illustrated in FIG. 2, the sample introducing arm 82 is used to introduce a biomolecule sample into the first opening 57 of the sample separating section 5. The sample introducing arm 82 holds a gel strip 80 which is supported by a support plate 81. The gel strip 80 is generally thin and flexible. Therefore, the gel strip 80 is not directly held by the sample introducing arm 82, but is held by the sample introducing arm 82 while the gel strip 80 is fixed to the support plate 81 which is made of an acrylic plate, a resin film, or the like.

Note that in Embodiment 1, two arms, the transfer film moving arm 70 and the sample introducing arm 82, are used. However, the present invention is not limited to such a configuration. Alternatively, the present invention can include only a single moving arm. In such a case, the single arm (70 or 82) can introduce a gel strip 80 into the first opening 57, and then hold and convey the transfer film 7 when the biomolecule sample is subjected to separation and transfer.

(Pressing Tool 6)

The pressing tool 6 is a member for (i) pressing, with a predetermined pressure, the transfer film 7 against the second opening 58 of the sample separating section 5 and (ii) preventing an electric current from flowing through any member between the sample separating section 5 and the anode 41 except (a) the slit 61a of the slit structure 61 and (b) the through-hole 62a of a fixing tool 62 (second structure). That is, the pressing tool 6 restricts, between the sample separating section 5 and the anode 41, a pathway (of electric current) of lines of electric force generated as a result of electric charge which is induced by voltage applied across the cathode 31 and the anode 41. Specifically, the pressing tool 6 prevents the buffer solution in the second buffer solution tank 4, which buffer solution serves a pathway through which an electric current flows, from coming into contact with the transfer film 7 via any part except the slit 61a of the slit structure 61 and the through-hole 62a of the fixing tool 62.

The pressing tool 6 is configured so that an elastic body 620 (elastic member) is sandwiched between (i) the slit structure 61 in which the slit 61a extends along the y-axis and (ii) the fixing tool 62. More specifically, the elastic body 620 is provided in a recess 62b which is provided at a slit structure 61-side of the fixing tool 62.

Slit Structure 61

The slit structure 61 is located at a part of the pressing tool 6, which part is closest to the transfer film 7 among all parts of the pressing tool 6. The slit structure 61 has a contact surface which is in contact with the transfer film 7.

The slit structure 61 has the slit 61a which (i) passes through the contact surface and a back surface and (ii) has a width of 50 μm to 300 μm along the y-axis. The slit 61a is located so as to correspond to the second opening 58. This causes lines of electric force, which occur between the cathode 31 and the anode 41, to be converged onto, as a convergent point, a center position of the slit 61a.

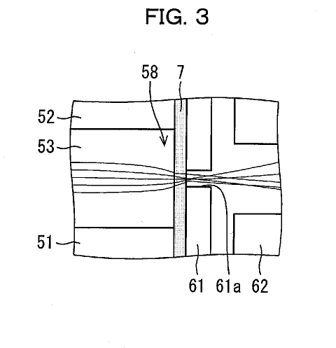

FIG. 3 is a view schematically illustrating lines of electric force at the transfer film 7 and in the vicinity of the transfer film 7, and is a view obtained by enlarging part of FIG. 2. Since the slit 61a is located on a back side (anode 41-side) of the transfer film 7, the lines of electric force can be narrowed in a part over the separation gel 53 to the slit 61a. This causes narrowed lines of electric force to pass through a part of the transfer film 7, which part is located on a front side (second opening 58-side) of the slit 61a. Since a biomolecule sample flows along lines of electric force, a biomolecule sample under the influence of the convergence is adsorbed to and held by the transfer film 7 while the biomolecule sample is concentrated. That is, it is possible to transfer a biomolecule sample to the transfer film 7 with a high resolution.

The width of the slit structure 61 along the y-axis, in particular, is configured to be less than a width (1.0 mm to 1.2 mm) of the second opening 58 of the sample separating section 5 along the y-axis. This allows inclinations of respective electric field vectors onto a convergent point to be large, and therefore allows for an increase in effect of concentrating a biomolecule sample to be adsorbed to the transfer film 7. Note that lines of electric force refer to lines which connect electric field vectors at each point.

In order to enhance the effect of converging the lines of electric force, the slit structure 61 is preferably made of a material having low conductivity and is more preferably made of an insulating material. Examples of a material for the slit structure 61 encompass glass, ceramic, and resin.

On an anode 41-side of the slit structure 61, there is a protrusion 61b provided so as to protrude toward the fixing tool 62.

Fixing Tool 62

The fixing tool 62 is located closer to the anode 41 than is the slit structure 61. The fixing tool 62 is firmly fixed to the housing 2 at a part where the fixing tool 62 is in contact with the housing 2. As in the case of the slit structure 61, the fixing tool 62 can be made of glass, ceramic, resin, or the like.

The fixing tool 62 has the through-hole 62a. The recess 62b is provided on a surface of the fixing tool 62 so as to surround the through-hole 62a, which surface is located on the slit structure 61-side of the fixing tool 62.

A width of the through-hole 62a is preferably equal to or greater than a width of the slit 61a, and is more preferably greater than the width of the slit 61a.

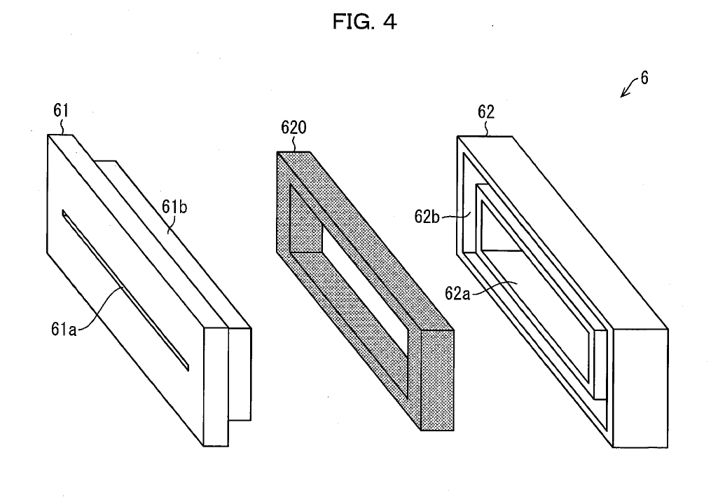

The recess 62b is located on the surface on the slit structure 61-side of the fixing tool 62. As illustrated in FIG. 4 which is an exploded perspective view of the pressing tool 6, the recess 62b serves as a groove having a hollow quadrilateral shape.

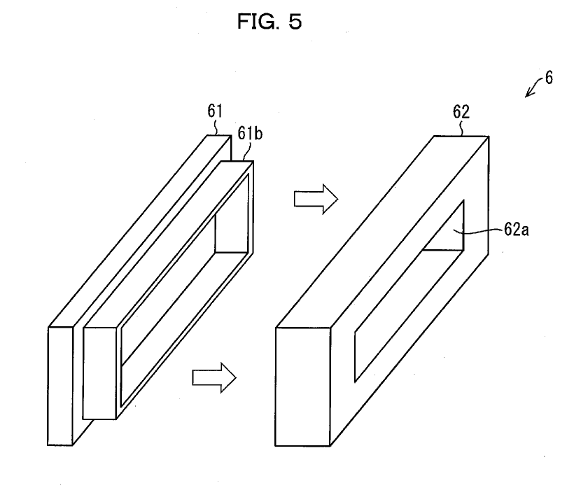

As illustrated in FIG. 5 which is an exploded perspective view of the pressing tool 6, the protrusion 61b (described above) provided on the slit structure 61 has a hollow quadrilateral shape so that the protrusion 61b can be inserted into the recess 62b which (i) has the hollow quadrilateral shape and (ii) is provided on the fixing tool 62. However, as described earlier, the elastic body 620 is provided so as to completely fill the recess 62b. Therefore, although the protrusion 61b applies a pressure to the elastic body 620, the protrusion 61b is pushed back by a restoring force of the elastic body 620. This causes the slit structure 61, which has the protrusion 61b, to be pushed back in a direction toward a negative side of the x axis. In a case where the slit structure 61 is thus pushed back, the slit structure 61 presses, with a fixed pressure, the transfer film 7 (which is located between the second opening 58 and the slit structure 61) in a direction from a second buffer solution tank 4-side of the transfer film 7 toward the second opening 58.

The above configuration is one of the characteristic features of Embodiment 1. Specifically, the fixing tool 62 and the elastic body 620 which is provided in the recess 62b of the fixing tool 62 (see FIG. 2) apply a pressure to the slit structure 61 in a direction toward the negative side of the x axis (toward the second opening 58). This (i) allows the slit formation surface (contact surface) of the slit structure 61 to remain in contact with the transfer film 7 and (ii) allows the transfer film 7 to remain in contact with the second opening 58. This allows the transfer film 7 to be provided in the proximity of a convergent point of lines of electric force in the slit 61a, and therefore makes it possible to achieve high-resolution sample adsorption while a biomolecule sample is subjected to separation and adsorption.

Note that in a case where (i) the transfer film 7 is pressed in the direction from the second buffer solution tank 4-side of the transfer film 7 toward the second opening 58 and (ii) the pressure is weak, it is not possible to cause the transfer film 7 to come into contact with the second opening 58. In contrast, in a case where (i) the transfer film 7 is pressed in the direction from the second buffer solution tank 4-side of the transfer film 7 toward the second opening 58 and (ii) the pressure is excessively strong, there is the following risk: In a case where the transfer film moving arm 70 is to pull up the transfer film 7 in the direction toward the positive side of the y-axis as illustrated in FIG. 2, it may not be possible to pull up the transfer film 7 because there is strong frictional resistance. That is, in the case where the transfer film 7 is pressed in the direction from the second buffer solution tank 4-side of the transfer film 7 toward the second opening 58, it is necessary to ensure precision in (i) positions of the sample separating section 5 and of the slit structure 61 in relation to each other and (ii) pressure applied by the slit structure 61 in the direction toward the negative side of the x axis. It is then necessary to cause frictional resistance to be small while the transfer film 7 is in contact with the second opening 58 and is pulled up in the direction toward the positive side of the y-axis.

Therefore, the biomolecular analysis device 1 of Embodiment 1 has, in the housing 2, (i) a structure in which the sample separating section 5 can be positioned and detachably fixed and (ii) a structure in which the fixing tool 62 can be positioned and fixed. This allows positions of the sample separating section 5 and of the slit structure 61 in relation to each other to be precisely set, and therefore allows a pressure applied by the slit structure 61 in the direction toward the negative side of the x axis to be suitably strong. The pressure applied by the slit structure 61 to the transfer film 7 is preferably 0.1 N to 10 N, and is more preferably 1 N to 5 N.

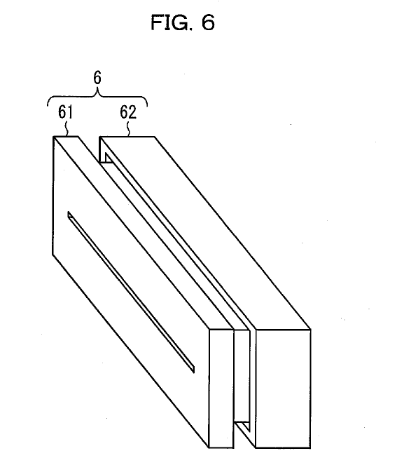

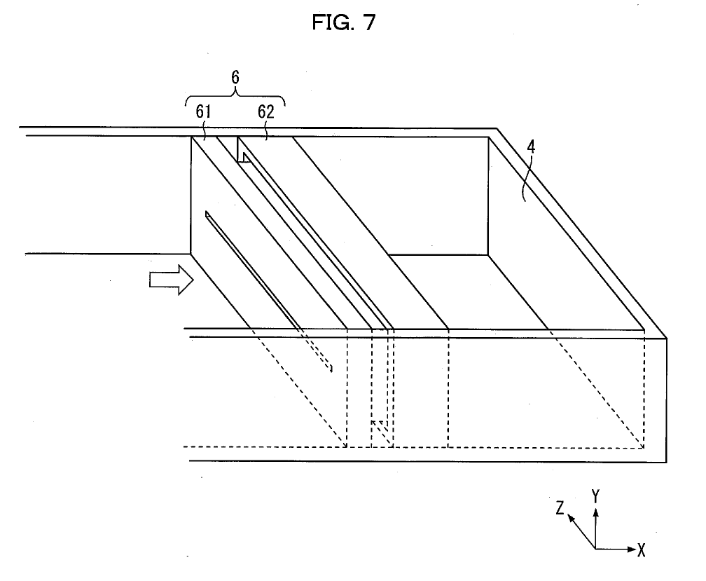

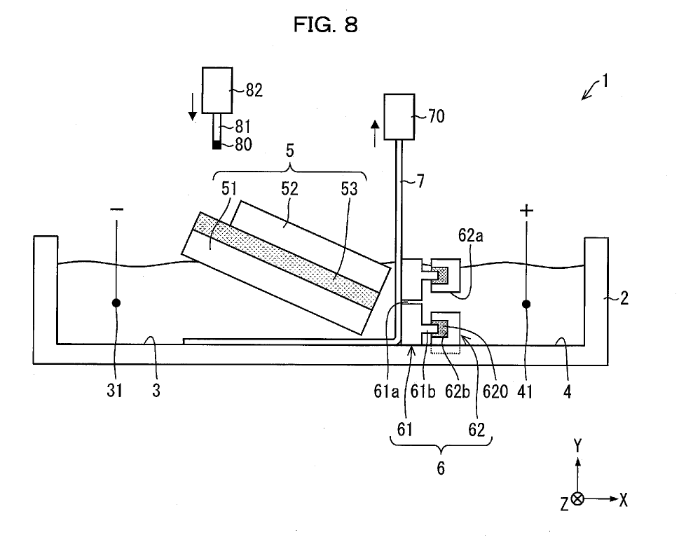

Note according to Embodiment 1, (i) the pressing tool 6, which is obtained by combining the slit structure 61 and the fixing tool 62 together (see FIG. 6), is provided by positioning and fixing the fixing tool 62 at a predetermined position in the housing 2 before the sample separating section 5 is provided (see FIG. 7) and then (ii) the sample separating section 5 is provided in the housing 2 (see FIG. 8). In a case where the sample separating section 5 is provided in the housing 2, the pressing tool 6 having a cushioning property allows the sample separating section 5 to be smoothly set in the biomolecular analysis device 1. In so doing, the sample separating section 5 pushes the slit structure 61 toward the fixing tool 62 in a direction indicated by an arrow illustrated in FIG. 7. Then, by the restoring force of the elastic body 620, the slit structure 61 is pushed back toward the sample separating section 5.

Note that elasticity of the elastic body 620 is also linked to the above-described contact and frictional resistance between the second opening 58 and the transfer film 7.

The elastic body 620 can be made of a material which is stretchable and which has low electrical conductivity or an insulating property. Examples of the material encompass a polymer, a rubber, a gel, and a sol. Specific examples of the rubber encompass a nitrile rubber, a fluorine rubber, a silicone rubber, an ethylene propylene rubber, a chloroprene rubber, an acrylic rubber, a butyl rubber, a urethane rubber, a natural rubber, a chlorosulfonated polyethylene rubber, and an epichlorohydrin rubber.

Note that Embodiment 1 assumes that the elastic body 620 is achieved by filling the recess 62b of the fixing tool 62, which recess 62b has a hollow quadrilateral shape, with a polymer, a rubber, a gel, a sol, or the like. Alternatively, a spring can be used as the elastic body 620.

The elastic body 620 is more preferably made of a material which (i) facilitates an adjustment of pressing force (pressure) applied by the slit structure 61 to the transfer film and (ii) has chemical resistance, heat resistance, and oxidation resistance. Examples of the material encompass, but are not limited to, silicon resin. The pressing force (pressure) applied by the slit structure 61 to the transfer film can be, but is not limited to, 3.45 N (±15%), for example.

Note that in a region between the slit structure 61 and the fixing tool 62, there is a cylindrical (restricting) space which (i) has one end opened by the slit 61a and the other end opened by the through-hole 62a and (ii) is formed by (a) the elastic body 620 having a loop shape (hollow quadrilateral shape) which surrounds an opening on an anode 41-side of the slit 61a and (b) the protrusion 61b of the slit structure 61 (see FIGS. 2 and 4). This space not only serves as a divider of a space but also electrically restricts (blocks) a space. Therefore, in a case where lines of electric force occurring as a result of applying voltage across the cathode 31 and the anode 41 pass through the slit 61a, the lines of electric force pass through the through-hole 62a. That is, by use of the elastic body 620 and the protrusion 61b, it is possible to restrict (limit) a pathway of lines of electric force to the slit 61a of the slit structure 61. Note that on a fixing tool 62-side, the elastic body 620 surrounds an opening of the through-hole 62a.

In addition, the fixing tool 62 is firmly fixed to the housing 2, so that a bottom part and both side parts of the fixing tool 62 are in contact with corresponding inner walls of the housing 2 so as to seal the bottom part and both the side parts of the fixing tool 62. Note that in a case where a water level of an anode-specific buffer solution to be provided in the second buffer solution tank 4 is set below a top part of the fixing tool 62, there is no continuity across the slit structure 61-side of the fixing tool 62 and the second buffer solution tank 4 except through the through-hole 62a which is provided at a center part of the fixing tool 62. This restricts (limits) the pathway of lines of electric force to the through-hole 62a of the fixing tool 62.

Assume a case where the pathway of lines of electric force is not thus restricted, so that the pathway does not pass through the slit 61a of the slit structure 61, but there is a pathway of electric current formed so as to, for example, flow around a bottom part of the slit structure 61. In such a case, there is a risk that the lines of electric force are not converged with respect to the x-axis, and therefore the lines of electric force are not substantially perpendicular to the transfer film 7. This may cause a reduction in precision with which a biomolecule sample is adsorbed to the transfer film 7. In contrast, by restricting the pathway so as to cause the lines of electric force to be converged onto the slit 61a of the slit structure 61 as in the case of Embodiment 1, it is possible to increase the precision with which a biomolecule sample is adsorbed to the transfer film 7.

In addition, according to Embodiment 1, a pressured part is located so as to surround a part onto which lines of electric force are converged. This allows an entire part of the contact surface in the slit structure 61, which is in contact with the transfer film 7, to be evenly pressed against the transfer film 7. For example, if a spring(s), instead of the fixing tool 62 and the elastic body 620, is used to push back the slit structure 61 from the second buffer solution tank 4-side, then it may be difficult to cause the slit structure 61 to evenly apply a pressure to the transfer film 7, depending on the number of springs and on a position of the spring(s) to be provided. This poses a risk that a sample may not be suitably adsorbed to the transfer film 7. In contrast, with the configuration according to Embodiment 1, it is possible to press the transfer film 7 against the second opening 58 with an even pressure. This allows the transfer film 7 to be suitably in contact with the second opening 58 so as to cause a biomolecule sample to be adsorbed to the transfer film 7 with a high resolution.

The elastic body 620 can be formed by (i) allowing an elastic body precursor (e.g. resin monomer) having a sol form to flow into the recess 62b which is provided in the fixing tool 62 so as to have a hollow quadrilateral shape and then (ii) causing the elastic precursor to be gelled (by polymerization reaction in which an organic chemical method or an optical method is used). Alternatively, the elastic body 620 can be formed by (i) forming, in advance, an elastic body 620 having a hollow quadrilateral shape as illustrated in FIG. 4 and then (ii) engaging the elastic body 620 with the recess 62b of the fixing tool 62, which recess 62b has a hollow quadrilateral shape. For example, in a case where the method of allowing a resin monomer to flow into the recess 62b and gelling the resin monomer is employed, there are the following advantages: (i) it is easy to produce the elastic body 620, (ii) it is possible to repeatedly use the elastic body 620, and (iii) it is possible to continuously analyze a biomolecule sample with good reproducibility without any adverse effect on electrophoresis.

(2) Separation and Adsorption of Biomolecule Sample by Use of Biomolecular Analysis Device

A flow of separation and adsorption of a biomolecule sample in the biomolecular analysis device 1 will be described next with reference to FIG. 2.

First, the sample introducing arm 82 holds a gel strip 80 which is supported by the support plate 81. Then, until the gel strip 80 is inserted into or is in contact with the first opening 57, the sample introducing arm 82 moves in a direction indicated by the arrow appearing next to the sample introducing arm 82 in FIG. 2. Note that the gel strip 80 contains components obtained by one dimensionally separating a biomolecule sample by isoelectric point electrophoresis.

While the gel strip 80 is inserted into or is in contact with the first opening 57, voltage is applied across the cathode 31 and the anode 41. This causes each of the components contained in the gel strip 80 to be further separated according to their molecular weights in a separation gel 53.

Alternatively, it is possible that a first dimensional electrophoresis section is incorporated into the biomolecular analysis device 1 of Embodiment 1. This automates steps from a step of first dimensional isoelectric point electrophoretic separation to a step of second dimensional electrophoretic separation and a step of transferring a biomolecule sample to the transfer film.

In a case where first dimensional electrophoresis is not carried out, it is only necessary to provide, in the separation gel 53, a well (depression) which is to be filled with a biomolecule sample. After the biomolecule sample is introduced into the well, the biomolecule sample is fixed with the use of an agarose gel or the like so that the biomolecule sample is prevented from flowing out into the first buffer solution tank 3. Alternatively, it is possible to mix a biomolecule sample with an agarose gel, introduce the mixture into the well, and then coagulate the mixture in the well.

The well is formed by a method similar to ordinary SDS-PAGE. Specifically, after a gel monomer solution (solution before being polymerized to be gelatinized) flows into the first opening 57 and before a gel monomer is polymerized, a comb (comb-like plate having a plurality of projections and depressions which ordinarily have a height (depth) of approximately 5 mm) is inserted into the first opening 57, and is then subjected to gelling. After the gelling, comb is removed, so that the well is formed.

After the biomolecule sample is introduced, the biomolecule sample is subjected to separation by electrophoresis through allowing an electric current to flow through the cathode 31 and the anode 41. A value of the electric current to flow through the electrodes is preferably 50 mA or less, and is more preferably 20 mA or more and 30 mA or less. This makes it possible to restrict heat generation while electrophoresis is carried out sufficiently fast. If a greater electric current flows, then electrophoresis can end in a shorter period of time. However, heat generation may become excessive. This poses a risk of having an adverse effect on a gel, a biomolecule sample, and/or the resolution of electrophoretic separation. Note, however, that if a powerful cooling device using a Peltier element is attached to a suitable part of the biomolecular analysis device 1, then excessive heat generation can be avoided. In such a case, it is possible to increase the value of the electric current to 100 mA or less.

Along with a progression of electrophoresis in the sample separating section 5, the transfer film 7 is gradually conveyed by driving of the transfer film moving arm 70 in the direction indicated by the arrow appearing next to the transfer film moving arm 70 in FIG. 2.

A judgment about whether or not separated components have reached the second opening 58 can be made by (i) mixing a stained marker in the biomolecule sample in advance and then (ii) checking a status of the electrophoresis at a position of the marker or measuring a voltage with the use of a monitor. The stained marker is preferably BPB (Bromophenol Blue) that is ordinarily used to check a leading part of electrophoresis. Examples of the monitor for measuring a voltage encompass a voltage monitor (voltage measuring section: not illustrated) for monitoring a voltage between the cathode 31 and the anode 41.

An operation carried out in a case where a voltage monitor will be described below. In a case where a biomolecule sample has reached the second opening 58, an electrical conductivity decreases at a part where the separation gel 53 and the transfer film 7 are in contact with each other, so that an electrical resistance between the electrodes increases. This causes a large increase in voltage. By monitoring this increase in voltage, it is possible to detect that the separated components have been released from the separation gel 53 and transferred to the transfer film 7.

In a case where a programming for monitoring a voltage is installed in the biomolecular analysis device 1, it is possible to automatically detect the release of a component from the separation gel 53 so that the transfer film moving arm 70 can start pulling up the transfer film 7.

Likewise, a speed, at which the transfer film 7 is pulled up after adsorption of the components is started, can also be controlled with the use of a voltage or an electric current. The speed, at which the transfer film 7 is pulled up, can be a speed at which a biomolecule sample is adsorbed to the transfer film 7 with a sufficient resolution, and can be set as appropriate by a person skilled in the art. By thus controlling the speed, it is possible to (i) reproduce a result of the transfer, (ii) avoid unnecessary use of the transfer film 7 (i.e. avoid generating a part to which no component is adsorbed), and (iii) decrease the biomolecular analysis device in size.

By the above process, it is possible to carry out, with the use of a single device, steps from a step of first dimensional or second dimensional electrophoresis to a step of transferring a biomolecule sample.

After the adsorption of the biomolecule sample component ends, the transfer film 7 is collected by the transfer film moving arm 70, and is then subjected to staining or immune reaction. Then, a separation pattern of the components adsorbed to the transfer film 7 is detected with the use of a fluorescent detector or the like. Such a fluorescent detector can be incorporated into the biomolecular analysis device 1. This allows an entire process including electrophoresis, transfer, and detection to be automated.

(3) Two Dimensional Electrophoresis Device

As described earlier, the biomolecular analysis device 1 can serve as a two dimensional electrophoresis device by (i) controlling the sample separating section 5 to serve as a second dimensional electrophoresis section and (ii) including a first dimensional electrophoresis section. In the first dimensional electrophoresis section, the gel strip 80 is used as a separation medium for first dimensional electrophoresis. Then, after the first dimensional electrophoresis (isoelectric point electrophoresis) is carried out, the sample introducing arm 82 inserts the gel strip 80 into the first opening 57 of the sample separating section 5.

With this configuration, it is possible to carry out steps from a step of first dimensional isoelectric point electrophoretic separation to a step of second dimensional electrophoretic separation and a step of transferring a biomolecule sample to the transfer film.

(4) Working Effect of Embodiment 1

According to the biomolecular analysis device 1 of Embodiment 1, the elastic body 620 presses the slit structure 61 toward the sample separating section 5. This causes the transfer film 7, which is provided between the slit 61a of the slit structure 61 and the second opening 58, to be in the proximity of the second opening 58. Therefore, separated biomolecule samples, which have been released from the second opening 58, can be adsorbed to the transfer film 7. This makes it possible to consecutively carry out steps from a step of separating a biomolecule sample by electrophoresis to a step of transferring the biomolecule sample to the transfer film 7. In addition, since the transfer film 7 is in the proximity of the second opening 58, separated biomolecule samples, which have been released from the second opening 58, can be efficiently adsorbed to the transfer film 7. This allows sample adsorption to be achieved with a high resolution.

The elastic body 620 restricts, to the slit 61a, a region between the second opening 58-side and the fixing tool 62-side of the slit structure 61, in which region there is a buffer solution. This prevents an electric current from flowing from a sample separating section 5-side to the anode 41-side of the pressing tool 6 through any part except (i) the slit 61a of the slit structure 61 and (ii) the through-hole 62a of the fixing tool 62. If this configuration is not employed and consequently an electric current flows through a part other than the slit 61a of the slit structure 61 and the through-hole 62a of the fixing tool 62, then lines of electric force are formed in the part. Since a biomolecule sample moves along lines of electric force, there is a risk that the biomolecule sample may flow randomly to a part other than the slit 61a of the slit structure 61 and the through-hole 62a of the fixing tool 62. This prevents the biomolecule sample from being concentrated on a specific part of the transfer film 7, and therefore causes a decrease in resolution.

However, according to Embodiment 1, the pressing tool 6 prevents a buffer solution in the second buffer solution tank 4, which buffer solution serves as a pathway through which an electric current flows, from coming into contact with the transfer film 7 via any part except the slit 61a of the slit structure 61 and the through-hole 62a of the fixing tool 62. This causes the biomolecule sample to be concentrated on and adsorbed to a specific part of the transfer film 7, and therefore allows high-resolution sample adsorption to be achieved.

Note that the biomolecular analysis device 1 is a horizontal device in which a sample is separated substantially horizontally. However, the present invention is not limited to such a configuration. Alternatively, the biomolecular analysis device 1 can be a vertical device.

[Variation 1]

According to Embodiment 1, a pathway of lines of electric force is restricted by fixing the elastic body 620 and the protrusion 61b to the fixing tool 62 so as to be sealed and fixed by the housing 2. However, the present invention is not limited to such a configuration. Alternatively, a pathway of lines of electric force can be restricted only by use of the elastic body 620 and the protrusion 61b each having a hollow quadrilateral shape.

According to Variation 1, a pathway of lines of electric force is restricted only by an elastic body 620 and a protrusion 61b each having a hollow quadrilateral shape. This (i) makes it unnecessary to fix a fixing tool 62 to a housing 2 so that the fixing tool 62 is sealed by the housing 2 and (ii) makes it only necessary to positionally fix the fixing tool 62 to the housing 2 enough to allow a slit structure 61 to be supported. For example, a structure to allow continuity across a slit structure 61-side and an anode 41-side of the fixing tool 62 can be provided outside of a region in the fixing tool 62, in which region the elastic body 620 is provided. As a specific example, a water level of an anode-specific buffer solution can be set above a top part of the fixing tool 62 as opposed to Embodiment 1 in which the water level of the anode-specific buffer solution is set below the top part of the fixing tool 62 as illustrated in FIG. 2.

### Embodiment 2

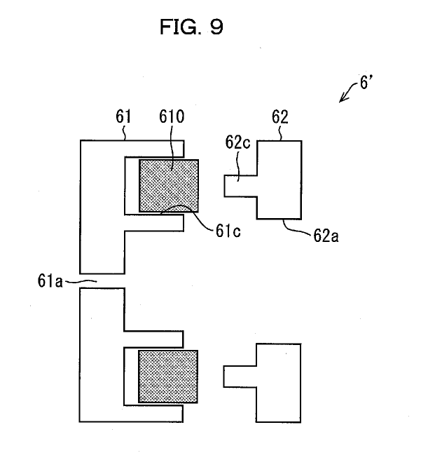

Shapes of a slit structure, an elastic body, and a fixing tool are not limited to those described in Embodiment 1, but can be those illustrated in FIG. 9. The following description will discuss another embodiment of the present invention with reference to FIG. 9. For convenience, members identical in function to those described in Embodiment 1 are given the same referenced numbers, and will not be described below.

FIG. 9 is a cross-sectional view illustrating a pressing tool which is included in a biomolecular analysis device of Embodiment 2. FIG. 9 is viewed from the same direction as in the case of FIG. 2. A pressing tool 6′ of Embodiment 2 is different from the pressing tool 6 of Embodiment 1 in terms of (i) projections and depressions and (ii) a position at which an elastic body is provided.

Specifically, as illustrated in FIG. 9, the pressing tool 6′ of Embodiment 2 is configured so that a recess 61c is provided on a fixing tool 62-side of a slit structure 61, whereas a protrusion 62c, which protrudes toward the slit structure 61, is provided on a slit structure 61-side of the fixing tool 62. An elastic body 610 (elastic member) is held in the recess 61c. In a case where a sample separating section 5 is provided, (i) the protrusion 62c is inserted into the elastic body 610 from the fixing tool 62-side and then (ii) the slit structure 61 is pushed back by a restoring force of the elastic body 610. This achieves, as in the case of Embodiment 1, a mechanism in which the slit structure 61 presses a transfer film toward a second opening.

### Embodiment 3

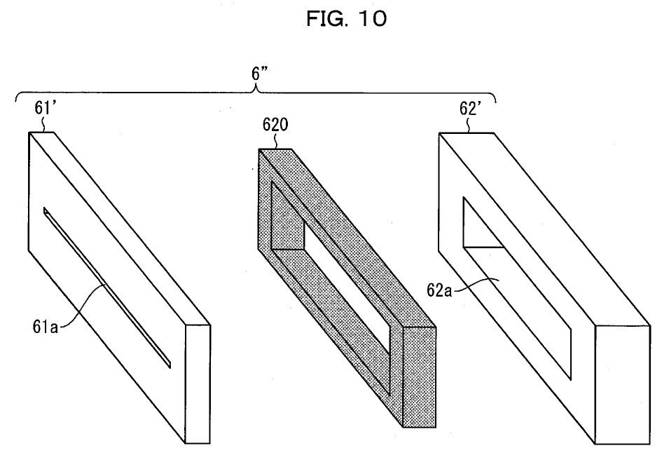

Shapes of a slit structure, an elastic body, and a fixing tool are not limited to those described in Embodiment 1, but can be those illustrated in FIG. 10. The following description will discuss another embodiment of the present invention with reference to FIG. 10. For convenience, members identical in function to those described in Embodiment 1 are given the same referenced numbers, and will not be described below.

FIG. 10 is a cross-sectional view illustrating a pressing tool which is included in a biomolecular analysis device of Embodiment 3. FIG. 10 is viewed from the same direction as in the case of FIG. 2. A pressing tool 6″ of Embodiment 3 is different from the pressing tool 6 of Embodiment 1 in that the pressing tool 6″ has no projections and depressions.

Specifically, as illustrated in FIG. 10, the pressing tool 6″ is configured so that a fixing tool 62′-side of a slit structure 61′ and a slit structure 61′-side of a fixing tool 62′ each have no projections and depressions and are each flat. Note, however, that the slit structure 61′ has a slit 61a, and the fixing tool 62 has a through-hole 62a.

Between the flat surfaces, an elastic body 620 is provided so as to have a hollow quadrilateral shape to form a cylindrical (restricting) space which has one end opened by the slit 61a and the other end opened by the through-hole 62a. According to Embodiment 1, a pressure is produced by the protrusion 61b penetrating into the elastic body 620. Embodiment 3 achieves a mechanism in which the slit structure 61 ‘ presses a transfer film toward a second opening as in the case of Embodiment 1 by causing the elastic body 620 to have a restoring force by pressing, against the elastic body 620, a surface of the slit structure 61’ which surface faces toward the fixing tool 62′.

By thus simply sandwiching the elastic body 620 between the slit structure 61′ and the fixing tool 62′, it is made possible to (i) easily replace the elastic body 620 and (ii) select an elastic body having any thickness and any hardness. In addition, in a case where an elastic body deteriorates over time, it is possible to easily replace only the elastic body.

### Embodiment 4

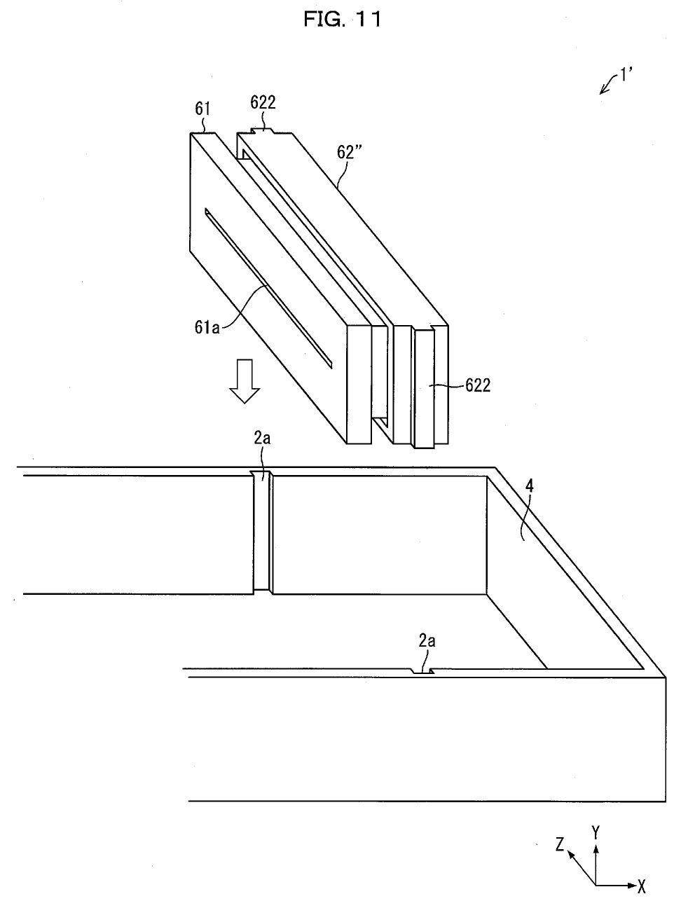

A method of fixing a fixing tool to a housing is not limited to the method described in Embodiment 1. Alternatively, a method illustrated in FIG. 11 can be used. Another embodiment of the present invention will be described below with reference to FIG. 11. For convenience, members identical in function to those described in Embodiment 1 are given the same referenced numbers, and will not be described below.

According to Embodiment 1, the bottom part and the side part of the fixing tool 6, each of which is flat, are firmly fixed to corresponding flat inner surfaces of the housing 2. However, the present invention is not limited to such a configuration. Alternatively, a biomolecular analysis device 1′ illustrated in FIG. 11 is configured so that (i) recessed grooves 2a are provided on respective predetermined positions inside the housing 2 and (ii) protruding parts 622, which are to be engaged with the corresponding recessed grooves 2a, are provided on respective side parts of a fixing tool 62. By engaging the recessed grooves 2a and the protruding parts 622 with each other, the fixing tool 62″ can be fixed to a predetermined position inside the housing 2. This (i) makes it possible to easily position the fixing tool 62″ inside the housing 2 and (ii) makes it unnecessary to use an adhesive or the like. Therefore, it is made easy to fix the fixing tool 62″ to the housing 2. In addition, since the recessed grooves 2a and the protruding parts 622 are engaged with each other, the fixing tool 62″ is highly reliably fixed to the housing 2. This allows a pressure of the slit structure 61 (toward a transfer film) to be certainly achieved.

### SUMMARY

As has been described, a biomolecular analysis device according to Aspect 1 of the present invention is a biomolecular analysis device in which (i) an electric current is allowed to flow through a separation medium (separation gel 53) via a buffer solution so that a biomolecule sample in the separation medium (separation gel 53) is separated into separated biomolecule samples and then (ii) the separated biomolecule samples are released from the separation medium (separation gel 53) and then adsorbed to an adsorbing member (transfer film 7), said biomolecular analysis device including: a first electrode (cathode 31); a second electrode (anode 41); a separating section (sample separating section 5) for storing the separation medium (separation gel 53), the separating section having (i) a first opening 57 which is made on a side facing toward the first electrode (cathode 31) and (ii) a second opening 58 which is made on a side facing toward the second electrode (anode 41); and a pressing tool (6, 6′, 6″) which is located between the separating section (sample separating section 5) and the second electrode (anode 41), the pressing tool (6, 6′, 6″) sandwiching an elastic member (elastic body 620, 610), which has an insulating property, between a first structure (slit structure 61) and a second structure (fixing tool 62, 62′, 62″), the first structure (slit structure 61) being provided on a side facing toward the separating section (sample separating section 5), and the second structure (fixing tool 62, 62′, 62″) being provided and positionally fixed on a side facing toward the second electrode (anode 41), the first structure (slit structure 61) having a first through-hole (slit 61a) which is located at a position facing the second opening 58 and which penetrates through the first structure (slit structure 61) from the side facing toward the separating section (sample separating section 5) to a side facing toward the second electrode (anode 41), the second structure (fixing tool 62, 62′, 62″) having a second through-hole (through-hole 62a of fixing tool 62, 62′, 62″) which is located at a position facing the second opening 58 and which penetrates through the second structure (fixing tool 62, 62′, 62″) from a side facing toward the separating section (sample separating section 5) to the side facing toward the second electrode (anode 41), the adsorbing member (transfer film 7) being provided between the second opening 58 and the first through-hole (slit 61a), the elastic member (elastic body 620, 610) pressing the first structure (slit structure 61) toward the separating section (sample separating section 5), the elastic member (elastic body 620, 610) having a loop shape which surrounds an opening of the first through-hole (slit 61a) on the side facing toward the second electrode (anode 41) and which surrounds an opening of the second through-hole (through-hole 62a) on the side facing toward the separating section such that the elastic member (elastic body 620, 610) having the loop shape restricts a channel of a buffer solution (anode-specific buffer solution) between the opening of the first through-hole and the opening of the second through-hole.

According to the configuration, the elastic member (elastic body 620, 610) presses the first structure (slit structure 61) toward the separating section (sample separating section 5). This causes the adsorbing member (transfer film 7), which is provided between the first through-hole (slit 61a) of the first structure (slit structure 61) and the second opening 58, to be in the proximity of the second opening 58. Therefore, the separated biomolecule samples, which have been released from the second opening 58, can be adsorbed to the adsorbing member (transfer film 7). This makes it possible to consecutively carry out steps from a step of separating a biomolecule sample by electrophoresis to a step of transferring the biomolecule sample to the adsorbing member (transfer film 7). In addition, since the adsorbing member (transfer film 7) is in the proximity of the second opening 58, separated biomolecule samples, which have been released from the second opening 58, can be efficiently adsorbed to the adsorbing member (transfer film 7). This allows sample adsorption to be achieved with a high resolution.

In addition, the elastic member (elastic body 620, 610) having an insulating property has a loop shape which surrounds the opening of the first through-hole (slit 61a) on the side facing toward the second electrode (anode 41) and which surrounds the opening of the second through-hole (through-hole 62a) on the side facing toward the separating section such that the elastic member (elastic body 620, 610) having the loop shape restricts the channel of the buffer solution between the opening of the of the first through-hole (slit 61a) and the opening of the second through-hole (through-hole 62a). This makes it possible to prevent the buffer solution in the second buffer solution tank 4, which buffer solution serves as a pathway through which an electric current flows, from coming into contact with the transfer film 7 via any part except the slit 61a of the slit structure 61 and the through-hole 62a of the fixing tool 62. If this configuration is not employed and consequently the channel of the buffer solution is not thus restricted between the side facing toward the separating section (sample separating section 5) and side facing toward the second structure (fixing tool 62, 62′, 62″) in the first structure (slit structure 61), then an electric current flows through a part in the buffer solution, which serves as a pathway through which the electric current flows, in the second buffer solution tank 4, which part is other than the first through-hole (slit 61a) of the first structure (slit structure 61). This causes lines of electric force to be formed in the part. Since a biomolecule sample moves along lines of electric force, there is a risk that the biomolecule sample may flow randomly to a part other than the first through-hole (slit 61a) of the first structure (slit structure 61). This prevents the biomolecule sample from being concentrated on a specific part of the adsorbing member (transfer film 7), and therefore causes a decrease in resolution. However, according to the present invention, a biomolecule sample is concentrated on and adsorbed to a specific part of the adsorbing member (transfer film 7) because a channel of a buffer solution is restricted as describe above. This allows high-resolution sample adsorption to be achieved.

Note that in a case where separated biomolecule samples are released from the separation medium and adsorbed to the adsorbing member (transfer film 7), a sample separation pattern can be obtained by moving the adsorbing member (transfer film 7) along a second axis which is perpendicular to a first axis extending through the first electrode (cathode 31) and the second electrode (anode 41).

According to the configuration, second dimensional electrophoresis and transfer can be consecutively carried out by setting, as a biomolecule sample in the separating section (sample separating section 5), a medium which has been subjected to first dimensional electrophoresis.

In Aspect 2 of the present invention, a biomolecular analysis device according to Aspect 1 of the present invention is arranged such that a recess (62b, 61c) for holding the elastic member (elastic body 620, 610) is provided on (i) a side of the second structure (fixing tool 62), which side faces toward the first structure (slit structure 61) or (ii) a side of the first structure (slit structure 61), which side faces toward the second structure (fixing tool 62).

According to the configuration, the elastic member (elastic body 620, 610) can be held. This makes it possible to provide a biomolecular analysis device in which continuous and reproducible analysis is possible without inconvenient desorption of the elastic member (elastic body 620, 610).

In Aspect 3 of the present invention, a biomolecular analysis device according to Aspect 1 or 2 of the present invention is arranged such that: a recess (62b, 61c) for holding the elastic member (elastic body 620, 610) is provided on either one of (i) the side of the second structure (fixing tool 62), which side faces toward the first structure (slit structure 61) and (ii) the side of the first structure (slit structure 61), which side faces toward the second structure (fixing tool 62); and a protrusion (61b, 62c) to be inserted into the elastic member (elastic body 620, 610) is provided on the other one of (i) the side of the second structure (fixing tool 62), which side faces toward the first structure (slit structure 61) and (ii) the side of the first structure (slit structure 61), which side faces toward the second structure (fixing tool 62).

According to the configuration, the protrusion (61b, 62c) and the elastic member (elastic body 620, 610) restrict a region in which there is a buffer solution. This allows a biomolecule sample to be concentrated on and adsorbed to a specific part of the adsorbing member (transfer film 7).

In Aspect 4 of the present invention, a biomolecular analysis device according to Aspects 1 through 3 of the present invention is arranged such that the elastic member (elastic body 620, 610) is made of a polymer, a rubber, a gel, or a sol.

In Aspect 5 of the present invention, a biomolecular analysis device according to Aspect 4 of the present invention is arranged such that the rubber is a nitrile rubber, a fluorine rubber, a silicone rubber, an ethylene propylene rubber, a chloroprene rubber, an acrylic rubber, a butyl rubber, a urethane rubber, a natural rubber, a chlorosulfonated polyethylene rubber, or an epichlorohydrin rubber.

In Aspect 6 of the present invention, a biomolecular analysis device according to Aspects 1 through 5 of the present invention is arranged such that, a width of the first through-hole (slit 61a) is less than a width of the second opening 58 with respect to a second axis which is perpendicular to a first axis extending through the first electrode (cathode 31) and the second electrode (anode 41).

With the configuration, the first through-hole (slit 61a) can control lines of electric force so that the lines of electric force are converged so as to be narrower than the second opening 58. This allows a biomolecule sample, which has been released from the second opening 58, to be converged so as to be narrower than a width of the second opening 58, and therefore allows high-resolution sample adsorption to be achieved.

In Aspect 7 of the present invention, a biomolecular analysis device according to Aspects 1 through 6 of the present invention is arranged such that the first electrode (cathode 31), the second opening 58, the first through-hole (slit 61a), the second through-hole (through-hole 62a), and the second electrode (anode 41) are arranged in line.

According to the configuration, a flow of lines of electric force in the vicinity of the second opening 58 of the separating section (sample separating section 5) is perpendicular to the adsorbing member (transfer film 7). This causes a biomolecule sample, which has been released from the second opening 58, to be perpendicularly adsorbed to the adsorbing member (transfer film 7). This allows for an increase in precision in sample adsorption.

In Aspect 8 of the present invention, a biomolecular analysis device according to Aspects 1 through 7 of the present invention is arranged to further include: an adsorbing member moving section (transfer film moving arm 70) for moving, at a position corresponding to the second opening 58, the adsorbing member (transfer film 7) along a second axis which is perpendicular to a first axis extending through the first electrode (cathode 31) and the second electrode (anode 41).

With the configuration, the adsorbing member (transfer film 7) can be moved along the second axis. This allows a more precise sample separation pattern to be obtained.

In Aspect 9 of the present invention, a biomolecular analysis device according to Aspects 1 through 8 of the present invention is arranged to further include: a first buffer solution tank 3 in which the first electrode (cathode 31) is provided; and a second buffer solution tank 4 in which the second electrode (anode 41) is provided, the first buffer solution tank 3 holding a first buffer solution (cathode-specific buffer solution) which is a buffer solution containing ethanol and having a pH of 6.5 to 8.8, and the second buffer solution tank 4 holding a second buffer solution (anode-specific buffer solution) which is a buffer solution containing MOPS or Tris.

In Aspect 10 of the present invention, a biomolecular analysis device according to Aspects 1 through 9 of the present invention is arranged to further include: a first dimensional electrophoresis section for carrying out first dimensional electrophoresis, the separating section (sample separating section 5) serving as a second dimensional electrophoresis section for carrying out second dimensional electrophoresis.

In Aspect 11 of the present invention, a biomolecular analysis device according to Aspect 10 of the present invention is arranged to further include: a medium moving section (sample introducing arm 82) for moving, to the separating section (sample separating section 5), a separation medium (gel strip 80) for the first dimensional electrophoresis, the separation medium for the first dimensional electrophoresis having been subjected to the first dimensional electrophoresis in the first dimensional electrophoresis section so that the biomolecule sample is separated.

With the configuration, it is possible to provide a two dimensional electrophoresis device in which it is possible to consecutively and automatically carry out steps from a step of first dimensional electrophoresis to a step of second dimensional electrophoresis by the separating section to a step of sample adsorption by the adsorbing member.

In Aspect 12 of the present invention, a biomolecular analysis device according to Aspects 1 through 11 of the present invention is arranged such that protein, DNA, or RNA can be used as the biomolecule sample.

### Example

The following description will discuss the present invention in more detail with reference to an example. However, the present invention is not limited to the following example.

In the following description, (i) “width” means a dimension along a Y-axis, (ii) “length” means a dimension along an X-axis, and (iii) “thickness” means a dimension along a Z-axis. The present example is based on the configuration described in Embodiment 1.

(Sample Separating Section)

As an example of the sample separating section 5 illustrated in FIG. 2, a sample separating section was formed by filling, with a separation medium having a thickness of 1 mm, a gap between two glass plates each having dimensions of 60 mm (width)×30 mm (length)×5 mm (thickness).

A second opening of the sample separating section was covered with a porous film (covering part) for which a commercially available Durapore (registered trademark) membrane filter (manufactured by Millipore Corporation) having a thickness of 0.65 μm.

A separation medium used was prepared so that (i) a protein separating gel (60 mm (width)×25 mm (length)×1 mm (thickness)) using a 10% polyacrylamide gel using a Bis-Tris buffer having a pH of 6.4 was located on a second opening-side of the sample separating section and (ii) a protein concentrating gel (60 mm (width)×5 mm (length)×1 mm (thickness)) using a 3% polyacrylamide gel was located on a first opening-side of the sample separating section.

(Pressing Tool)

As an example of the slit structure 61 illustrated in FIG. 2, a slit structure was prepared by use of an acrylic material so that (i) a width along the z-axis was 75 mm, (ii) a width along the y-axis was 24 mm, and (iii) a width along the x-axis (width between a contact surface and an end of the protrusion 61b (see FIG. 2)) was 8 mm. A length by which the protrusion 61b of FIG. 1 protruded was 4 mm. A width of a slit along the y-axis was 300 μm. A width of the protrusion 61b having a hollow quadrilateral shape (see FIG. 2) along the y-axis was 9 mm.

The fixing tool 62 illustrated in FIG. 2 was prepared by use of an acrylic material so that (i) a width along the z-axis was 75 mm, (ii) a width along the y-axis was 24 mm, and (iii) a width along the x-axis was 8 mm. The through-hole 62a (see FIG. 2) was prepared so that (i) a width along the z-axis was 65 mm and (ii) a width along the y-axis was 10 mm μm. The recess 62b (see FIG. 2) was prepared so that (i) a width along the z-axis was 65 mm, (ii) a width along the y-axis was 5 mm, and (iii) a depth (along the x-axis) was 8 mm.

The elastic body 620 illustrated in FIG. 2 was formed by (i) allowing a silicone rubber into the recess of the fixing tool so as to completely fill the recess with the silicone rubber and then (iii) polymerizing the silicone rubber.

(Electrode, Buffer Solution, and Transfer Film)

Next, the sample separating section, to which a porous film (transfer auxiliary body) was attached, was set in the biomolecular analysis device. Then, a first buffer solution tank, in which a cathode was to be provided, was filled with a MOPS buffer (manufactured by Invitrogen Corporation) having a pH of 7.3. A second buffer solution tank, in which an anode was to be provided, was filled with 100 mM MOPS (having a pH of 7.3) and 20% ethanol. Note that a cathode made of a platinum needle was provided in the first buffer solution tank, and an anode made of a platinum needle was provided in the second buffer solution tank. Note that the transfer auxiliary body refers to a hydrophilic film whose pore diameter (pore size) is 100 μm or less. The transfer auxiliary body can be attached to the second opening of the sample separating section by use of an adhesive, thermocompression bonding, a double-sided tape or the like.

Next, a transfer film, which was obtained by subjecting Immobiron FL (manufactured by Millipore Corporation) (which is a commercially available PVDF film) to a hydrophilization treatment by use of ethanol in advance, was immersed in a buffer solution. In addition, a top part of the transfer film was fixed to a transfer film moving arm 70 as illustrated in FIG. 2.

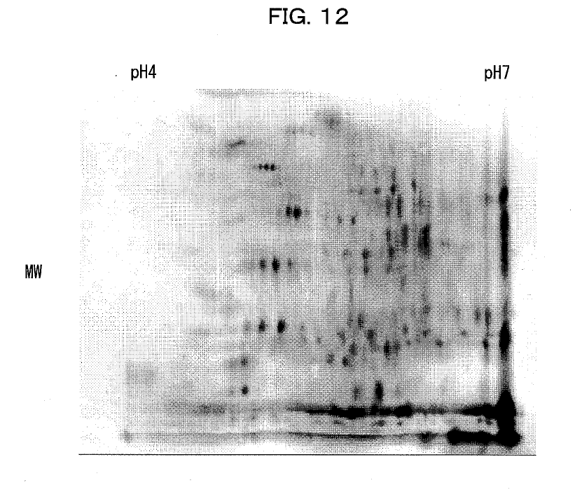

FIG. 12 shows a photograph of the transfer film after sample adsorption. FIG. 12 shows that a biomolecule sample was separated and developed to the transfer film in the present example.

The present invention is not limited to the descriptions of the embodiments and the example, but can be altered in many ways by a person skilled in the art within the scope of the claims. An embodiment derived from a proper combination of technical means disclosed in different embodiments and the example is also encompassed in the technical scope of the present invention. Furthermore, a new technical feature can be obtained by a combination of technical means disclosed in the different embodiments.

### INDUSTRIAL APPLICABILITY

A biomolecular analysis device of the present invention can be used for, for example, research and development of drugs, and can be applied to diagnostic medical equipment.

### REFERENCE SIGNS LIST

1, 1′ Biomolecular analysis device

2 Housing

2a Recessed groove

3 First buffer solution tank

4 Second buffer solution tank

5 Sample separating section

6, 6′, 6″ Pressing tool

7 Transfer film

31 Cathode (first electrode)

41 Anode (second electrode)

51 Lower plate

52 Upper plate

53 Separation gel

57 First opening

58 Second opening

61, 61′ Slit structure (first structure)

61a Slit (first through-hole)

61b Protrusion

61c Recess

62, 62′, 62″ Fixing tool (second structure)

62a Through-hole (second through-hole)

62b Recess

62c Protrusion

70 Transfer film moving arm (adsorbing member moving section)

80 Gel strip (separation medium for first dimensional electrophoresis)

81 Support plate

82 Sample introducing arm (medium moving section)

610, 620 Elastic body (elastic member)

622 Protruding part

1: A biomolecular analysis device in which (i) an electric current is allowed to flow through a separation medium via a buffer solution so that a biomolecule sample in the separation medium is separated into separated biomolecule samples and then (ii) the separated biomolecule samples are released from the separation medium and then adsorbed to an adsorbing member, said biomolecular analysis device comprising:
a first electrode;
a second electrode;
a separating section for storing the separation medium, the separating section having (i) a first opening which is made on a side facing toward the first electrode and (ii) a second opening which is made on a side facing toward the second electrode; and
a pressing tool which is located between the separating section and the second electrode,
the pressing tool sandwiching an elastic member, which has an insulating property, between a first structure and a second structure, the first structure being provided on a side facing toward the separating section, and the second structure being provided and positionally fixed on a side facing toward the second electrode,
the first structure having a first through-hole which is located at a position facing the second opening and which penetrates through the first structure from the side facing toward the separating section to a side facing toward the second electrode,
the second structure having a second through-hole which is located at a position facing the second opening and which penetrates through the second structure from a side facing toward the separating section to the side facing toward the second electrode,
the adsorbing member being provided between the second opening and the first through-hole,
the elastic member pressing the first structure toward the separating section,
the elastic member having a loop shape which surrounds an opening of the first through-hole on the side facing toward the second electrode and which surrounds an opening of the second through-hole on the side facing toward the separating section such that the elastic member having the loop shape restricts a channel of a buffer solution between the opening of the first through-hole and the opening of the second through-hole.

2: The biomolecular analysis device as set forth in claim 1, wherein
a recess for holding the elastic member is provided on (i) a side of the second structure, which side faces toward the first structure or (ii) a side of the first structure, which side faces toward the second structure.

3: The biomolecular analysis device as set forth in claim 1, wherein:
a recess for holding the elastic member is provided on either one of (i) the side of the second structure, which side faces toward the first structure and (ii) the side of the first structure, which side faces toward the second structure; and
a protrusion to be inserted into the elastic member is provided on the other one of (i) the side of the second structure, which side faces toward the first structure and (ii) the side of the first structure, which side faces toward the second structure.

4: The biomolecular analysis device as set forth in claim 1, wherein
the elastic member is made of a polymer, a rubber, a gel, or a sol.

5: The biomolecular analysis device as set forth in claim 4, wherein
the rubber is a nitrile rubber, a fluorine rubber, a silicone rubber, an ethylene propylene rubber, a chloroprene rubber, an acrylic rubber, a butyl rubber, a urethane rubber, a natural rubber, a chlorosulfonated polyethylene rubber, or an epichlorohydrin rubber.

6: The biomolecular analysis device as set forth in claim 1, wherein
a width of the first through-hole is less than a width of the second opening with respect to a second axis which is perpendicular to a first axis extending through the first electrode and the second electrode.

7: The biomolecular analysis device as set forth in claim 1, wherein
the first electrode, the second opening, the first through-hole, the second through-hole, and the second electrode are arranged in line.

8: A biomolecular analysis device as set forth in claim 1, further comprising:
an adsorbing member moving section for moving, at a position corresponding to the second opening, the adsorbing member along a second axis which is perpendicular to a first axis extending through the first electrode and the second electrode.

9: A biomolecular analysis device as set forth in claim 1, further comprising:
a first buffer solution tank in which the first electrode is provided; and
a second buffer solution tank in which the second electrode is provided,
the first buffer solution tank holding a first buffer solution which is a buffer solution containing ethanol and having a pH of 6.5 to 8.8, and
the second buffer solution tank holding a second buffer solution which is a buffer solution containing MOPS or Tris.

10: A biomolecular analysis device as set forth in claim 1, further comprising:
a first dimensional electrophoresis section for carrying out first dimensional electrophoresis,
the separating section serving as a second dimensional electrophoresis section for carrying out second dimensional electrophoresis.

11: A biomolecular analysis device as set forth in claim 10, further comprising:
a medium moving section for moving, to the separating section, a separation medium for the first dimensional electrophoresis, the separation medium for the first dimensional electrophoresis having been subjected to the first dimensional electrophoresis in the first dimensional electrophoresis section so that the biomolecule sample is separated.

12: The biomolecular analysis device as set forth in in claim 1, wherein
the biomolecule sample is protein, DNA, or RNA.
